(19) United States
(12) Patent Application Publication
(10) Pub. No.: US 2016/0272181 A1
(43) Pub. Date: Sep. 22, 2016

(54) PUMP STRUCTURE OF ELECTRIC INTEGRATED HYDRAULIC BRAKE DEVICE

(71) Applicant: MANDO CORPORATION, Gyeonggi-do (KR)

(72) Inventor: Young Song LEE, Gyeonggi-do (KR)

(73) Assignee: MANDO CORPORATION, Gyeonggi-do (KR)

(21) Appl. No.: 15/073,571

(22) Filed: Mar. 17, 2016

(30) Foreign Application Priority Data
Mar. 21, 2015 (KR) 10-2015-0039438

(51) Int. Cl. B60T 13/16; F04B 17/03; F04B 19/22; F16H 25/22

(52) U.S. Cl. CPC B60T 13/16; F16H 25/2204; B60T 13/161; F04B 17/03; F04B 19/22

(57) ABSTRACT

The present invention relates to a pump structure of an electric integrated hydraulic brake device, and more particularly, to a pump structure of an electric integrated hydraulic brake device, which is applied to an inside of a motor having a hollow. The pump structure of an electric integrated hydraulic brake device includes a motor (100) provided with a hollow, a ball screw (120) provided inside the hollow and connected and rotated with a rotor of the motor (100), a ball nut (130) provided inside the hollow, connected with the ball screw (120), and moved in a reciprocal direction according to a rotational direction of the ball screw (120), a guide (140) provided inside the hollow, provided at one end portion of the ball nut (130) and configured to press an adjacent piston (180), and a supporter (150) formed in one end portion of the ball screw (120) to rotate together with the ball screw (120), and provided opposite the other end portion of the ball nut (130).

### CROSS-REFERENCE TO RELATED APPLICATION

This application claims priority to and the benefit of Korean Patent Application No. 10-2015-0039438, filed on Mar. 21, 2015, the disclosure of which is incorporated herein by reference in its entirety.

### BACKGROUND

1. Field of the Invention

The present invention relates to a pump structure of an electric integrated hydraulic brake device, and more particularly, to a pump structure of an electric integrated hydraulic brake device, which is applied to an inside of a motor having a hollow.

2. Discussion of Related Art

Recently, a hybrid car, a fuel cell car, an electric car and the like have been actively developed to enhance a fuel efficiency and reduce an exhaust gas. These vehicles are necessarily equipped with a brake device, wherein the brake device for a vehicle is a device to decrease the speed of a running vehicle and to halt the vehicle.

Conventionally, there are a vacuum brake to generate a braking force using a suction pressure of an engine, and a hydraulic brake to generate a braking force using a hydraulic pressure.

The vacuum brake is a device that exerts a big braking force by a vacuum booster using a pressure difference between a suction pressure of a vehicle engine and atmospheric pressure though a small force of a driver. That is, the vacuum brake is a device that generates a much bigger force than the force pressed by stepping a brake pedal by the driver.

Such a conventional vacuum brake needs to be supplied with a suction pressure of a vehicle engine to make a vacuum for a vacuum booster, and therefore, there is a problem in that a fuel efficiency decreases. Further, when a vehicle stops, there is a problem in that an engine should be always driven to make a vacuum.

Since the fuel cell car and the electric car have no engine, the conventional vacuum brake, which amplifies the pedal effort of the driver when a brake pedal is stepped, cannot be applied. In the case of a hybrid car, since a stop function of idling should be implemented to improve a fuel efficiency, a hydraulic brake is needed.

As described above, the fuel cell car and the electric car need a recovery braking implementation to improve the fuel efficiency, and the recovery braking is easily implemented when the hydraulic brake is applied.

Meanwhile, an electric hydraulic brake device as a type of a hydraulic brake is a brake device that generates a braking force by sensing stepping of a brake pedal by the driver using an electric control unit (ECU), supplying a hydraulic pressure to a master cylinder, and delivering a braking hydraulic pressure to a wheel cylinder of each wheel.

Such an electric hydraulic brake device includes, as each unit, an actuator constituted of a master cylinder, a power booster, a reservoir, a pedal simulator, and the like to control a hydraulic braking pressure delivered to a wheel cylinder, an electronic stability control (ESC) to separately control a braking force of each wheel, and a hydraulic power unit (HPU) constituted of a motor, a pump, accumulator, etc.

FIG. 4 is a cross-sectional view of a pump structure of a conventional electric integrated hydraulic brake device.

The HPU has been further developed using a structure in which an eccentric shaft integrally formed with a spindle of a motor presses a piston of a hydraulic pump to introduce and exhaust a hydraulic pressure. Accordingly, as illustrated in FIG. 1, an electric integrated hydraulic brake device has been developed to press a piston by converting the rotation of a motor into a linear movement through a movement converting member such as a ball screw. However, such an electric integrated hydraulic brake device has a problem in that the length of the hydraulic brake device increases due to the motor and a hydraulic pump arranged in a line.

### PRIOR ART DOCUMENT

### Patent Document

Korean Patent Unexamined Publication No. 10-2013-0038432

### SUMMARY OF THE INVENTION

To solve the above described problems, the present invention provides a pump structure of an electric integrated hydraulic brake device capable of reducing the length of a conventional electric integrated hydraulic brake device.

The present invention also provides a pump structure of an electric integrated hydraulic brake device capable of effectively enduring a repulsive force generated by a high pressure being generated according to disposing of a pump operation unit inside a hollow motor.

The present invention also provides a pump structure of an electric integrated hydraulic brake device capable of effectively pressing by matching left and right movements of a piston and a ball nut when a pump operation unit is assembled to be disposed inside a hollow motor.

To achieve the purposes described above, an aspect of the present invention provides a pump structure of an electric integrated hydraulic brake device including a motor provided with a hollow, a ball screw provided inside the hollow and connected and rotated with a rotor of the motor, a ball nut provided inside the hollow, connected with the ball screw, and moved in a reciprocal direction according to a rotational direction of the ball screw, a guide provided inside the hollow, provided at one end portion of the ball nut and configured to press an adjacent piston, and a supporter formed in one end portion of the ball screw to rotate together with the ball screw and provided opposite the other end portion of the ball nut.

The pump structure may further include a sleeve formed to surround an outer circumferential surface of the piston and forcibly inserted into one side of a valve block of which is coupled to the motor.

The pump structure may further include a pump housing configured to accommodate the piston and one side of the pump housing coupled to the other side of the valve block.

One side of the piston may be coupled to the supporter, a groove may be formed in the other side of the piston so that a sidewall is formed, and a protrusion may be formed on a seating surface of the groove and separated from the sidewall.

The pump structure may further include an elastic member of which one side presses the seating surface while the protrusion is inserted thereinto, and the other side presses an inside of the other side of the pump housing.

The pump structure may further include at least one guide ring disposed in the pump housing and configured to be in contact with an outer circumferential surface of the sidewall to guide a reciprocal movement of the piston.

The pump structure may further include a sealing member disposed in the pump housing so that fluids accommodated inside the pump housing are prevented from leaking to the motor and the valve block.

The pump structure may further include a ball bearing provided inside the hollow and formed to surround an outer circumferential surface of the supporter.

The ball bearing may include a double angular ball bearing.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic view illustrating an electric integrated hydraulic brake device;

FIG. 2 is a cross-sectional view of a pump structure of an electric integrated hydraulic brake device according to an embodiment of the present invention;

FIG. 3 is a cross-sectional view illustrating one end portion of a piston in a pump of an electric integrated hydraulic brake device according to an embodiment of the present invention in more detail; and

FIG. 4 is a cross-sectional view of a pump structure of a conventional electric integrated hydraulic brake device.

### DETAILED DESCRIPTION OF EXEMPLARY EMBODIMENTS

Hereinafter, exemplary embodiments of a pump structure of an electric integrated hydraulic brake device according to the present invention will be described in detail with reference to the accompanying drawings. First, when reference numerals are assigned to elements of each drawing, if the same elements are illustrated in different drawings, the same reference numerals are assigned to the same elements whenever possible. Also, in descriptions of the present invention, when detailed descriptions of related known configurations or functions are deemed to unnecessarily obscure the gist of the present invention, they will be omitted.

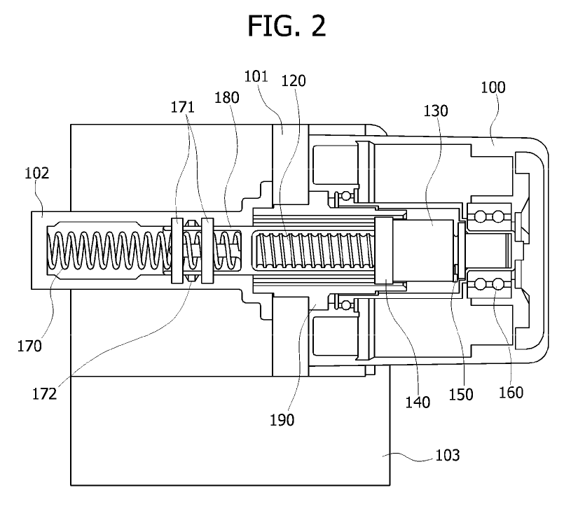

Before a description of the pump structure of an electric integrated hydraulic brake device according to an embodiment of the present invention, the electric integrated hydraulic brake device will be described with reference to FIG. 2. FIG. 2 is a schematic view illustrating the electric integrated hydraulic brake device.

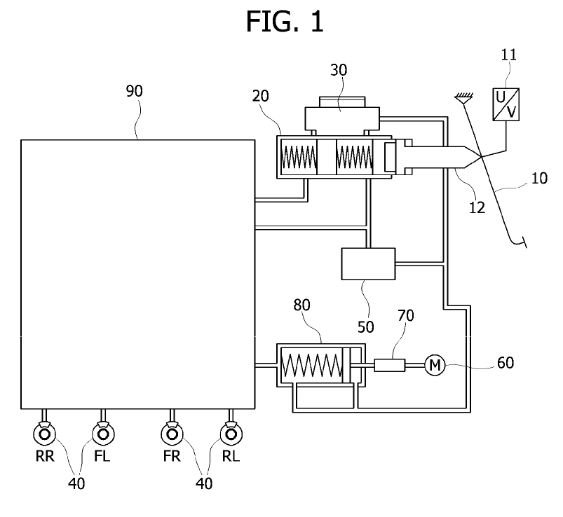

The electric integrated hydraulic brake device, as illustrated in FIG. 1, includes a master cylinder 20, a reservoir 30, a wheel cylinder 40, a pedal simulator 50, a motor 60, a gear unit 70 and a pump 80.

The master cylinder 20 is pressurized by an input load 12 and generates a hydraulic pressure when a driver steps on the brake pedal 10. The generated hydraulic pressure is transferred to the pedal simulator 50, the pedal simulator 50 transfers a repulsive force corresponding to the hydraulic pressure to the brake pedal 10 through the master cylinder 20, and thus the driver experiences pedal feel. Further, the hydraulic pressure of the master cylinder 20 is directly transferred to the wheel cylinder 40 to stop a vehicle when an emergency, such as no power supplied to the overall system, etc., occurs.

Meanwhile, in a normal situation, the pump 80 transfers fluids to the wheel cylinder 40. Specifically, when the driver steps on the brake pedal 10, a stroke sensor 11 detects a displacement of the brake pedal 10 to transfer the displacement to the electric control unit, and the electric control unit drives the motor 60 based on the displacement of the brake pedal 10. The rotational movement generated by the motor 60 is converted into a linear reciprocating movement by the gear unit 70 to press a piston in the pump 80, and then the fluids accommodated in the pump 80 flow into the wheel cylinder 40.

The reservoir 30 is a container which reserves fluids and provided to communicate with the master cylinder 20, the pedal simulator 50 and the pump 80. Further, a hydraulic circuit unit 90 includes a flow path through which the fluids of the master cylinder 20, the pump 80 and the wheel cylinder 40 which are described above is transferred, and valves that control a flow of the fluids in the flow path. A detailed description thereof will be omitted.

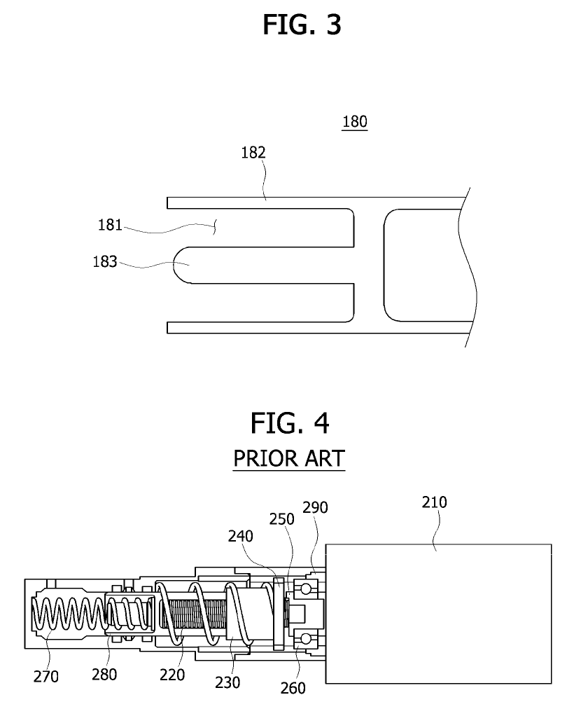

Hereinafter, a pump structure of an electric integrated hydraulic brake device according to an embodiment of the present invention will be described with reference to FIGS. 2 and 3. FIG. 2 is a cross-sectional view of the pump structure of the electric integrated hydraulic brake device according to the embodiment of the present invention, and FIG. 3 is a cross-sectional view particularly illustrating one end portion of a piston in the pump of the electric integrated hydraulic brake device according to the embodiment of the present invention.

As known in FIG. 2, the pump structure of the electric integrated hydraulic brake device according to the embodiment of the present invention includes a motor 100, a ball screw 120, a ball nut 130, a guide 140, a supporter 150, and a sleeve 190.

The motor 100 may be a hollow type motor. Unlike a conventional electric integrated hydraulic brake device using a solid shaft type motor, the electric integrated hydraulic brake device according to the embodiment of the present invention uses the motor having a hollow thereinside.

The conventional electric integrated hydraulic brake device separately provides the solid shaft type motor and a pump operation unit. Therefore, there is a problem in that the length of a hydraulic brake device increases because a piston for operating a pump and a ball screw for compressing the piston are positioned in a line.

However, although the hollow type motor is used instead of the solid shaft type motor according to the present invention, and the piston for operating the pump and the ball screw for compressing the piston which are positioned in a line are the same as the conventional electric integrated hydraulic brake device, they are formed inside the motor, thereby having an effect to decrease the length of the hydraulic brake device.

The motor 100 uses a brushless AC (BLAC) motor.

The BLAC motor rotates a rotor by alternating a current direction according to an angle of rotation using a speed controller without a brush and a commutator. The speed controller converts DC power having a positive and a negative polarities into three phase AC power to supply to the BLAC motor, detects the positions of fixed magnets based on the voltages supplied to three fixed coils, changes the phases, and thereby, the BLAC motor rotates.

The ball screw 120 is provided inside a hollow of the motor 100. The ball screw 120 is fixedly disposed at a rotor of the motor. When the rotor of the motor 100 rotates, the ball screw 120 connected with the rotor also rotates. Rotational movement of the ball screw 120 is converted into an axial force to be described below and reciprocates the ball nut 130 in forward and backward directions.

The conventional electric integrated hydraulic brake device provides the ball screw disposed outside the solid shaft type motor, but the electric integrated hydraulic brake device according to the present invention provides the ball screw disposed inside the hollow type motor to decrease the length of the hydraulic brake device.

The ball nut 130 is provided inside the hollow of the motor 100. The ball nut 130 installed outside the ball screw 120 includes an inner circumferential groove spirally extending to correspond to an outer circumferential groove of the ball screw 120, and in addition, a plurality of ball bearings made of a steel may be inserted between the outer and inner circumferential grooves which are disposed to face each other.

The guide 140 is provided inside the hollow of the motor 100. Referring to FIG. 2, the guide 140 is disposed between the ball nut 130 and a piston 180 on an outer circumferential surface of the ball screw 120. When the ball screw 120 is rotated by rotation of the motor 100, the ball nut 130 is moved in a line to move the guide 140. Here, the guide 140 presses the piston 180 to enable the pump to be operated.

The supporter 150 is formed on one end portion of the ball screw 120 to rotate together with the ball screw 120. Further, the supporter 150 is disposed to face one end portion of the ball nut 130. The supporter 150 is formed on an end portion of the hollow of the motor 100 to support the ball screw 120 and rotate together with the ball screw 120.

Meanwhile, the pump structure of the electric integrated hydraulic brake device according to the present invention provides a pump housing 102 having one side coupled to a valve block 101, which accommodates the piston 180. That is, the piston 180 may discharge the fluids included in the pump housing 102 to the wheel cylinder or the reservoir, or receive the fluids from the wheel cylinder or the reservoir while the piston 180 is moved with a linear reciprocating movement inside the pump housing 102. As illustrated in FIG. 2, the piston 180 has one side coupled to the supporter 150 and the other side coupled to an elastic member 170. Specifically, as illustrated in FIG. 3, a groove 181 is formed on the other side of the piston 180 so that a sidewall 182 is formed and a protrusion 183 separated from the sidewall 182 is formed on a seating surface of the groove 181.

One side of the elastic member 170 is inserted into the groove 181 to press the seating surface while being fitted into the protrusion 183, and the other side is disposed inside the pump housing 102 to press the inside of the other side of the pump housing 102.

In addition, as illustrated in FIG. 2, the pump structure of the electric integrated hydraulic brake device according to the present invention may further include a guide ring 171 and a sealing member 172. The guide ring 171 is disposed in the pump housing 102 to be in contact with an outer circumferential surface of the sidewall 182 of the piston 180 and thus performs to guide a linear reciprocating movement of the piston 180. Further, the sealing member 172 is disposed in the pump housing 102 so that the fluids accommodated inside the pump housing 102 can be prevented from leaking to the motor 100 and the valve block 101.

A ball bearing 160 is provided inside the hollow of the motor 100 and formed to surround an outer circumferential surface of the supporter 150. In order to endure weight in an axial direction when the ball nut 130 and the piston 180 are moved in linear forward and backward directions inside the motor 100, the ball bearing 160 may be preferably formed as a double angular ball bearing. In such a configuration, a repulsive force by high pressure being generated due to disposing an operation unit of the pump inside the hollow motor may be stood.

The sleeve 190 is formed to surround to an outer circumferential surface of the piston 180. Further, the sleeve 190 is formed to surround to a part of the ball nut 130. The ball nut 130 is moved in forward and backward directions and in a line along a groove formed in the sleeve 190.

The sleeve 190 may be forcibly inserted into the valve block 101 coupled to the motor 100. That is, the sleeve 190 serves to overlap a part of the motor 100 and the valve block 101 and to couple the motor 100 and the valve block 101.

Here, the sleeve 190 is configured to be aligned with a concentric center of the valve block 101 when the motor 100 and the valve block 101 are assembled. In such a configuration, the center of movement of the operation unit of the pump formed inside the motor is aligned with the center of movement of the valve block 101 to secure workability.

As described above, in the pump structure of an electric integrated hydraulic brake device according to the embodiment of the present invention, a hollow motor is applied instead of a conventional solid shaft motor and the operation unit of the pump is disposed inside the hollow motor in an overlapped state in an axial direction, thereby having an effect to reduce the length of a hydraulic brake device.

Further, as illustrated in FIG. 2, the motor 100, the valve block 101 and an electric control unit 103 are integrally embodied to reduce the size so that the installability to the vehicle can be increased.

As described above, according to the present invention, a hollow motor is applied instead of a conventional solid shaft motor, and by using the hollow motor, a piston for operating a pump inside a hollow and a ball screw for compressing the piston are aligned in a line, thereby having an effect to reduce the length of an electric integrated hydraulic brake device.

Further, according to the present invention, a ball bearing is disposed around a supporter which is formed in one end portion of the ball screw and opposite one end portion of a ball nut, thereby having an effect to effectively endure a repulsive force generated by a high pressure being generated by disposing a pump operation unit inside the hollow motor.

Further, according to the present invention, a sleeve surrounds an outer circumferential surface of the piston disposed inside the hollow motor and is forcibly inserted into a valve block coupled to the hollow motor, thereby having an effect to match the centers of movement of the valve block and the pump operation unit formed inside the motor to secure workability.

The above-described embodiments are only examples according to an aspect of the present invention and it will be understood by those skilled in the art that various modifications and alterations may be made without departing from the spirit and scope of the invention. Therefore, the embodiments disclosed in this specification should be considered in a descriptive sense only and not for purposes of limitation. Accordingly, the scope of the invention is not limited by the embodiments. The scope of the invention is defined by the appended claims and encompasses all modifications and equivalents that fall within the scope of the appended claims.

What is claimed is:

1. A pump structure of an electric integrated hydraulic brake device, comprising:
a motor provided with a hollow;
a ball screw provided inside the hollow and connected and rotated with a rotor of the motor;
a ball nut provided inside the hollow, connected with the ball screw, and moved in a reciprocal direction according to a rotational direction of the ball screw;
a guide provided inside the hollow, provided at one end portion of the ball nut and configured to press an adjacent piston; and
a supporter formed in one end portion of the ball screw to rotate together with the ball screw and provided opposite the other end portion of the ball nut.

2. The pump structure of claim 1, further comprising a sleeve formed to surround an outer circumferential surface of the piston and forcibly inserted into a valve block of which one side is coupled to the motor.

3. The pump structure of claim 2, further comprising a pump housing of which one side is coupled to the other side of the valve block and the pump housing configured to accommodate the piston.

4. The pump structure of claim 3, wherein:
one side of the piston is coupled to the supporter;
a groove is formed in the other side of the piston so that a sidewall is formed; and
a protrusion is formed on a seating surface of the groove and separated from the sidewall.

5. The pump structure of claim 4, further comprising an elastic member of which one side presses the seating surface while the protrusion is inserted thereinto, and the other side presses an inside of the other side of the pump housing.

6. The pump structure of claim 4, further comprising at least one guide ring disposed in the pump housing and configured to be in contact with an outer circumferential surface of the sidewall to guide a reciprocal movement of the piston.

7. The pump structure of claim 3, further comprising a sealing member disposed in the pump housing so that fluids accommodated inside the pump housing are prevented from leaking to the motor and the valve block.

8. The pump structure of claim 1, further comprising a ball bearing provided inside the hollow and formed to surround an outer circumferential surface of the supporter.

9. The pump structure of claim 8, wherein the ball bearing includes a double angular ball bearing.
